(19) United States
(12) Patent Application Publication
(10) Pub. No.: US 2003/0161398 A1
(43) Pub. Date: Aug. 28, 2003

(54) Improving static picture quality in compressed video

(76) Inventors: Meir Feder, Herzliya (IL); Eitan Federovski, Rishon Lezion (IL)

Correspondence Address: LEE & HAYES PLLC, 421 W RIVERSIDE AVENUE SUITE 500, SPOKANE, WA, 99201

(21) Appl. No.: 10/080,422

(22) Filed: Feb. 21, 2002

(51) Int. Cl. H04N 7/12

(52) U.S. Cl. 375/240.03; 375/240.2; 375/240.24

(57) ABSTRACT

A method of transmitting an image over a compressed video transport, as part of an image stream, comprising determining at least one quality for at least a part of an image based on a rate of change of said part; and transmitting said image part at said quality using said transport. Optionally, the image is static. Optionally, an improvement of the image is transmitted after a time.

### FIELD OF THE INVENTION

The present invention relates to the field of transmitting static images using a moving image compression method, such as MPEG.

### BACKGROUND OF THE INVENTION

Server-based interactive TV provided over basic set-top boxes often requires sending images rendered at the server, using an MPEG data stream. A problem arises if static images are being transmitted, rather than dynamic images for which MPEG was designed. If the designed bit-rate is not high enough, the MPEG format, designed for motion video, compromises the quality of these static pictures. However, using a high bit-rate will make the system non-scaleable. Exemplary interactive TV systems are described for example in PCT publications WO 00/07091, WO 00/07372, WO 00/07372, the disclosures of which are incorporated herein by reference.

U.S. Pat. No. 5,422,674, to Hooper et al., the disclosure of which is incorporated herein by reference, describes an image transmission system in which an image having a menu is transmitted progressively over a cable network, with the image being transmitted as an I-image and the menu being transmitted as a series of P-frames.

PCT publication WO 99/28858, describes a system for transmitting medical images using wavelet compression, in which the compression parameters are set so that the quality of the image is related to the final diagnostic use of the image.

In the MPEG standard, updates that are representative of changes in an image portion are transmitted using one or more of the following three ways: replacement of image portions, indication of movement of an image portion and transmission of DCT coefficients that encode the difference between a previous image and a current image. These DCT coefficients are typically generated by subtracting a current image portion from a previous image portion and then applying a DCT transform to the difference.

### SUMMARY OF THE INVENTION

An aspect of some embodiments of the invention relates to a method of transmitting a static or semi-static image over a compressed video transport, in which the image is transmitted as a basic frame (e.g., I-frame) followed by a plurality of improvement frames (e.g., P-frames). In an exemplary embodiment of the invention, a determination that an image is static is determined after the fact rather than before transmitting, for example, while transmitting the P-frames. In an exemplary embodiment of the invention, a receiving and decompressing station used to receive the image(s) is not modified and the static image is transmitted as part of a generalized stream including static and non-static images and/or image parts.

An aspect of some embodiments of the invention relates to setting a quality level for an image to be transmitted by a compressed image stream, based on the degree of temporal variation in the image. This degree of variation may be, for example, estimated based on past behavior. Alternatively or additionally, hints are used to indicate an expected degree of variation. In an exemplary embodiment of the invention, a fast varying image is provided with a low quality level and a static image with an intermediate quality level. In an exemplary embodiment of the invention, the quality level of the image is changed to match change sin degree of variation, for example, as an image becomes more static its quality goes up.

In an exemplary embodiment of the invention, the quality of a displayed image is improved over time by providing incremental improvements. In a static image, these improvements may, for example, result in a high quality image. In slowly varying images, the result may be a medium quality image with the quality going down each time the underlying image changes. Optionally, especially if such abrupt changes in quality are disconcerting, the system may be set up to provide a constant quality for images that vary faster than a threshold amount.

An aspect of some embodiments of the invention relates to a method of calculating change values for P-frames of a static image in which a decoder-encoder loop is not required. In an exemplary embodiment of the invention, previously sent DCT coefficients for the image are compared to high quality coefficients and the difference is directly encoded as DCT coefficients for transmission as P-frames that provide an incremental improvement in the displayed image.

In an exemplary embodiment of the invention, the MPEG encoding process is as follows. First, the image being transmitted is analyzed to see if it is static or not (e.g., by checking the number of changes in a macroblock relative to a previous macroblock, optionally taking into account block-motion of the relevant portion of the image, for example caused by scrolling). A quality level is then associated with the macroblock. A replacement macroblock or a change indication is then generated for the macro-block based on the quality level and using previous DCT coefficients used for that macroblock, to determine change indications. In an exemplary embodiment of the invention, when an intra frame is generated, it is selected to set quantization values similar to those that are currently attained by the static frame as a result of the continuous improvement.

While efficient calculation of coefficients is described with reference to DCT coefficients, it may be used, in various embodiments of the invention, for other linear transforms (e.g., DST, FFT and Hadamard) and transform-based compression methods, which use a transform the converts data into coefficients using a transform, including for example wavelet compression.

There is thus provided in accordance with an exemplary embodiment of the invention, a method of transmitting an image over a compressed video transport, as part of an image stream, comprising:

determining at least one quality for at least a part of an image based on a rate of change of said part; and

transmitting said image part at said quality using said transport. Optionally, the method comprises generating and transmitting a data block of image enhancement data if said image part did not change in a time period. Optionally, said generating comprises generating without decoding previously used DCT coefficients.

In an exemplary embodiment of the invention, said image part is a static image that does not change in at least 30 frames. Alternatively, said image part is a static image that does not change in at least 300 frames. Alternatively, said image part is a static image that does not change in at least 5 seconds. Alternatively, said image part is a static image that does not change in at least 25 seconds.

In an exemplary embodiment of the invention, the method comprises not transmitting image enhancement data once a target image quality is reached for said image part.

In an exemplary embodiment of the invention, the method comprises repeating said generating and said transmitting a maximum of a predetermined number of times for said image part.

In an exemplary embodiment of the invention, said transport comprises an MPEG-type transport. Optionally, the method comprises decoding said image using a standard MPEG decoder, to have a temporally progressive quality of said image part.

In an exemplary embodiment of the invention, the method comprises calculating a synchronisation frame for said transport by mapping a representation of said image as transmitted to a representation of said image as it should be in a synchronisation frame.

In an exemplary embodiment of the invention, the method comprises associating with said image part an indication of a suitable target quality for said image part.

In an exemplary embodiment of the invention, the method comprises associating with said image part an indication of a suitable initial quality for said image part.

In an exemplary embodiment of the invention, the method comprises associating with said image part an indication of an expected rate of change of said part. Optionally, the method comprises generating said indication by an image generator that generates said image. Alternatively or additionally, the method comprises generating said indication by an image encoder that encodes said image. Alternatively or additionally, the method comprises generating said indication by analysing a past profile of changes of said part.

There is also provided in accordance with an exemplary embodiment of the invention, a method of calculating a DCT coefficient change values for updating image values of a previously transmitted portion of an image without motion estimation, comprising:

comparing DCT coefficients that represent said image with at least an approximation of DCT coefficients that represent the transmitted image, to generate an indication of a difference between said coefficients; and

calculating an update coefficient set from said indication of a difference. Optionally, comparing comprises subtracting. Alternatively or additionally, calculating comprises quantizing said difference.

In an exemplary embodiment of the invention, said approximation comprises a composite of previously transmitted DCT coefficients and updates. Alternatively or additionally, said approximation comprises an AAN-type approximation, in which at least some of multiplication steps required to calculate DCT coefficients are performed as scaling multiplications. Optionally, said calculating comprises quantizing as part of said scaling multiplication.

There is also provided in accordance with an exemplary embodiment of the invention, a method of calculating a synchronisation frame, comprising:

providing a DCT coefficient set that represents a currently displayed image;

mapping said coefficients to a set of quantized coefficients that use a synchronisation frame type quantization. Optionally, mapping comprises mapping using a table.

There is also provided in accordance with an exemplary embodiment of the invention, a method of setting an initial quality of an image part of a compressed video stream, comprising:

selectively determining for at least a part of an image an expected change rate;

compressing said image part at a compression quality different than that of other parts of said stream responsive to said expected change rate. Optionally, said compression comprises quantizing a set of transform coefficients. Alternatively or additionally, compressing comprises compressing responsive to an indication of a desired quality of said image part.

In an exemplary embodiment of the invention, determining comprises determining based on a provided indication. Alternatively or additionally, said determining comprises determining based on an analysis of historical changes in said part.

In an exemplary embodiment of the invention, said image part is static. Alternatively, said image part is fast varying and is assigned a lower quality than average. Alternatively, said image part is semi-static and is a higher quality than average.

There is also provided in accordance with an exemplary embodiment of the invention, a method of transmitting an image over a compressed video transport, as part of an image stream, comprising:

transmitting an image using said transport;

determining that an image part of said image did not change in a time period; and

generating and transmitting a data block of image enhancement data responsive to said determination.

There is also provided in accordance with an exemplary embodiment of the invention, a method of calculating a coefficient change value set for updating image values of a previously transmitted portion of an image without motion estimation, which image is transmitted using a transform-type compression system that quantizes a linearly transformed image, comprising:

comparing transform coefficients that represent said image with at least an approximation of transform coefficients that represent the transmitted image, to generate an indication of a difference between said coefficients; and

calculating an update coefficient set from said indication of a difference.

### BRIEF DESCRIPTION OF THE FIGURES

Particular embodiments of the invention will be described with reference to the following description of exemplary embodiments in conjunction with the figures, wherein identical structures, elements or parts which appear in more than one figure are preferably labeled with a same or similar number in all the figures in which they appear, in which:

FIG. 1 is a schematic block diagram of an image transmission configuration in accordance with an exemplary embodiment of the invention;

FIG. 2 is a flowchart of a method of detecting an image type and associating an encoding quality therewith, in accordance with an exemplary embodiment of the invention;

FIG. 3 is a flowchart of a method of calculating incremental coefficients, in accordance with an exemplary embodiment of the invention; and

FIG. 4 is a flowchart of a method of calculating synchronization frames, in accordance with an exemplary embodiment of the invention.

### DETAILED DESCRIPTION OF EXEMPLARY EMBODIMENTS

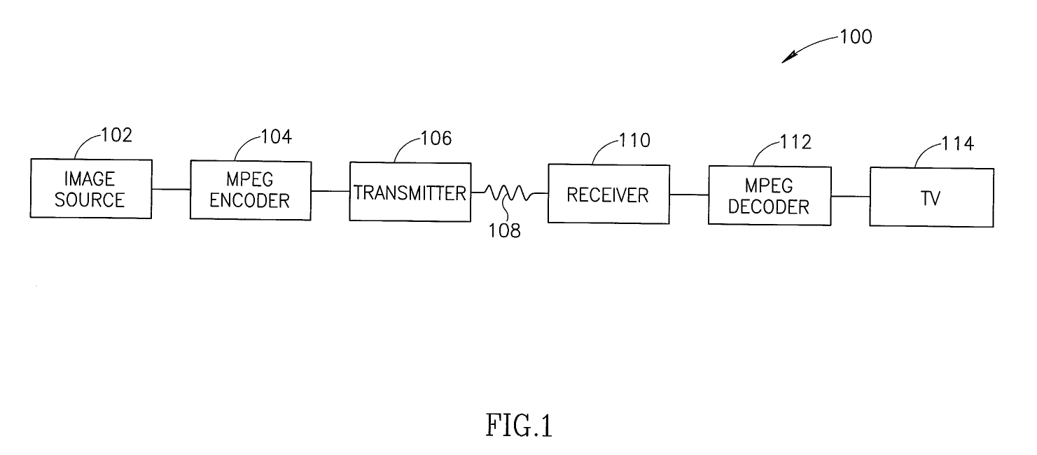

FIG. 1 is a schematic block diagram of an image transmission configuration 100 in accordance with an exemplary embodiment of the invention. An image source 102, for example a storage or a computer, generate a display. Many configurations are optimized for transmission of dynamic displays. However, often, a static image is generated and displayed, for a considerable time period (e.g., several seconds, which can be hundreds of frames). The generated display is then encoded, for example using an MPEG encoder 104, transmitted by a transmitter 106 as a signal over a medium, such as a cable or satellite medium 108, to be received by a receiver 110 in a user's home set-top box (for example). The set-top box further includes a decoder 112 which converts the received signal into a display suitable for a TV 114. In some cases, MPEG decoder 104 is hard wired into the set-top box, TV 114 and/or other devices that the user (or the distribution company) may have invested in. The first three PCT publications of the background, describe an exemplary distribution system in which Internet access and/or computer generated information may be interactively distributed using a cable network.

As is well known, the MPEG compression method generates two main types of frames, I-frames, which include DCT encoded sections of an image and P-frames which define changes to be accumulated to the I-frame and/or to replacement macroblocks in previous P-frames. This allows dynamic portions of an image to be coded by the changes relative to a previously transmitted image. However, when a static image is transmitted using this method, the I-frame contains the entire image and the P-frames are empty, thus requiring an early decision at what quality to send the image, even though there is no way of knowing if the image will change in the future.

In an exemplary embodiment of the invention, a static image is encoded and transmitted at a lower than maximum quality and then the quality of the image or parts thereof is improved over time, if the image is indeed static. Optionally, hints are associated with the image, for example by the encoder or the image generator. Such hints may indicate, for example, that quality in a certain area is less important (e.g., background) or more important (e.g., a menu), with the result that the initial quality and/or update rate and/or update numbers for the areas is varied according to the need and/or provided in an order of priority. Optionally, such hints are used to ensure that bandwidth is allocated for enhancing parts of the image that require enhancement and/or to prevent visual artifacts.

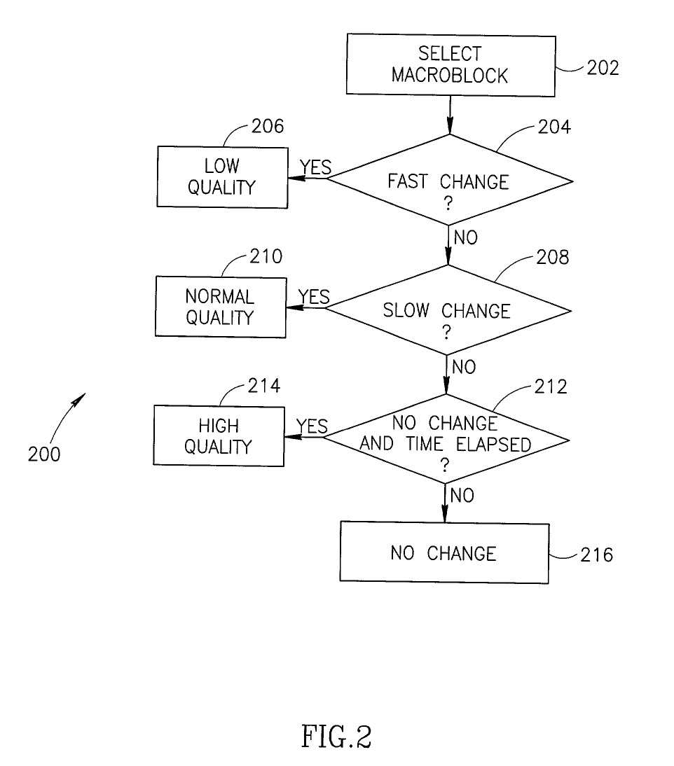

FIG. 2 is a flowchart 200 of a method of detecting an image type and associating an encoding quality therewith, in accordance with an exemplary embodiment of the invention. Optionally, the determination is on a macroblock level rather than an image-wide level, thus allowing different parts of a display to be treated differently.

In an exemplary embodiment of the invention, the coding quality includes two parameters: degree of quantization and highest used DCT frequency. Alternatively or additionally, other ways of defining coding quality, for example as known in the art, which may use the same or other parameters and/or of lesser or greater number may be used. The parameters may be absolute, for example relative to predefined values or they may be relative within the image, for example defining relative quantization between two parts of an image, with absolute values depending on available bandwidth. In some embodiments of the invention, the quality parameters define a function to be used in calculating and/or applying the quality parameter. In an exemplary embodiment of the invention, three quality levels are used, however, a higher or lower number of levels may be used and different number of quality levels may be provided for higher than average quality levels and lower than average levels. Alternatively or additionally, the difference in quality between levels and/or number of qualities relative to a standard quality may be asymmetric. Also, images with different characteristics (e.g., images, text and graphics) may have different parameter values for the different image qualities.

At 202, a macroblock is selected for consideration. In an exemplary embodiment of the invention, the macroblock is selected based on a change being requested in the macroblock by image source 102, in course of image generation. Alternatively or additionally, all blocks or blocks that are not changed are periodically polled (e.g., with the period being associated with a time threshold for changing quality). However, in such a case, some of steps 204-216 may be skipped, as being tautologic.

At 204, a determination is optionally made if the macroblock is changing rapidly. In one example, a determination is made if the time between the last change and a current change is below a threshold. Alternatively, more sophisticated methods may be applied, for example, a temporal average of a change rate. In addition, optionally, this and other thresholds (if any) may be fixed or allowed to vary within the image or between images. In an exemplary embodiment of the invention, the image generator provides instructions to the encoder regarding desired quality of different images or parts thereof. Alternatively or additionally, the generator provides hints, for example, indicating areas where change may be expected and areas where change is not to be expected. In an exemplary embodiment of the invention, the hints are generated by analyzing image portions over time, for example, to tentatively identify menu portions and background portions. Such hints may be used instead of or in addition to macroblock analysis at the generator or the compressor.

If the change is rapid (or more rapid than before, e.g., if a change rate is stored for the macroblock), a lower quality (206) is optionally assigned. This may prevent that macroblock from using up more than its share of bandwidth. The lower quality may be relative to a current assigned quality. Alternatively, it may be a specific low quality level, for example, if only two or three quality levels are supported. If a larger number of quality levels are supported, a specific quality level to be achieved may be determined on the fly, for example based on macroblock content or rate of change or an associated (stored) quality level may be reduced.

At 208, a determination is optionally made if the macroblock is changing slowly. If so, a normal (or higher than before) quality is optionally associated therewith (210).

At 212, a determination is optionally made if the macroblock did not change in a while (e.g., over a threshold or based on a function). If so, it is a static macroblock and a quality increment (214) may be in order. Otherwise, the quality associated with a macroblock may remain unchanged (216).

It should be noted that in some implementations, each macroblock has associated with it a history of quality, change rate and/or quality parameters. In some cases, these values are relative between the macroblocks.

After a quality level is associated with the macroblock, the macroblock may be encoded and quantized based on the quality level. If no change is detected (or a change below a threshold for updating), a P-frame that represents differences is transmitted instead of (or in addition to) an I-frame that includes replacement macroblocks.

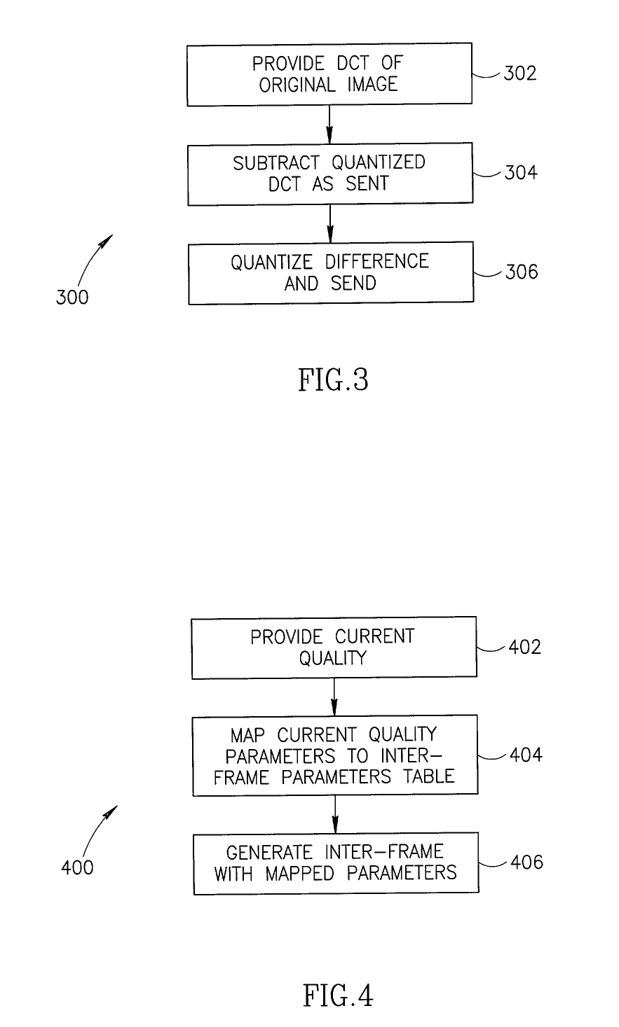

FIG. 3 is a flowchart 300 of a method of calculating incremental coefficients, in accordance with an exemplary embodiment of the invention. In a standard video stream, simply comparing the current and previous DCT coefficients is meaningless, as anything other than the exact difference between the coefficients may cause a reduction in the total image quality, by adding artifacts. However, the inventors have realized that in a static image, where both sets of coefficients (current and past) are approximations of the same image, a calculation based solely on the coefficients may well (and apparently does) yield incremental values that can improve an image quality. Thus, calculation of incremental coefficients is performed by subtracting high quality coefficients (e.g., of the stored static image) from previously sent lower quality coefficients and then suitably encoding the difference. It should be noted that the high quality coefficients and/or previously sent coefficients may be locally stored so there is no need to recalculate them unless the macroblock changes. Optionally, the AAN method (described for example in “JPEG Still Image Data Compression Standard” by William B. Pennebaker and Joan L. Mitchell, published by Van Nostrand Reinhold, 1993, ISBN 0-442-01272-1, especially FIGS. 4-8, the disclosure of which is incorporated herein by reference) is used instead of regular DCT, as it often faster to execute. This method is based on the idea that although an 8-point DCT requires 11 multiply operations at least, the computation can be rearranged so that many of the multiply operations are simple scaling of the final outputs. These multiply operations can then be folded into the multiply operations or divisions by the MPEG quantization table entries. The AAN method leaves only 5 multiply operations and 29 addition operations to be done in the DCT itself. While the use of fixed point arithmetic may result in reduced quality, due to limitations of the quantization table, this is not an issue for many applications.

In an exemplary embodiment of the invention, the following implementation is used. At 302, DCT coefficients of the original macroblock are provided, for example, being stored. At 304, the quantized coefficients that were actually sent are subtracted from these coefficients. At 306, the difference is requantized and used in a P-frame. The refined data is sent as an “inter” macroblock, and so the related parameters are given for the scales and tables of an “inter” macroblock/ or frame as known in the art. If more than three quality levels are used, it may be desirable to accumulate and store the current DCT coefficients.

If, however, the ANN method is used, a further reduction in processing can be achieved, as the complete coefficients do not need to be calculated. In the ANN method, pseudo-coefficients are calculated in one or two dimensions, using a non-DCT linear transform, and then the coefficients are corrected by multiplying them by a vector. This multiplication can also be used for quantization. In an exemplary embodiment of the invention, the pseudo-DCT values of the source macroblock multiplied by a vector (an example of which is described below) which simultaneously represents the difference between the real and previous sent DCT coefficients and also performs the quantization. A different such vector may be provided for each quality level.

The number of enhancement updates sent may be limited, for example, if the difference between the current image and the transmitted image are below a threshold or after a fixed number of updates are sent. The number of updates may depend, for example, on one or more of the initial quality, the image type (e.g., high frequency dominant, low frequency dominant) and/or a target image quality.

In an exemplary embodiment of the invention, the following formula is used to calculate the error-correction DCT coefficients to send for updating the static image quality.

Assuming:

x=value after AAN without the multiply stage

b=value of multiplication factor of AAN

q₁=first quantization value

q₂=second quantization value, q₂<q₁

y₁=quantized value using q₁

y₂=quantized value of residual error using q₂

Then:

y₁=integer (x·b/q₁)

y₂=integer((x·b−y₁·q₁)/q₂)

or:

y₂=integer(x·b/q₂−y₁·q₁/q₂)

Because a divide operation is usually considered expensive, multiply with shift may be used instead:

a/b≅(a·integer(2ⁿ/b))>>n

so:

y₁=(x·(b·2ⁿ/q₁))>>n

or if we pre compute

b₁=b·2ⁿ/q₁;

Then:

y₁=(x·b₁)>>n

and

y₂=(x·b·2ⁿ/q₂−y₁·q₁·2ⁿ/q₂)>>n;

And, if we pre compute:

b₂=b·2ⁿ/q₂,

b₁₂=q₁·2ⁿ/q₂

Then:

y₂=(x·b₂−y₁·b₁₂)>>n

FIG. 4 is a flowchart 400 of a method of calculating synchronization frames, in accordance with an exemplary embodiment of the invention. In the MPEG standard synchronization frames (I-frames) typically have different quantization tables than P-Frames, since they are required to encode absolute images, rather than differences (e.g., different dynamic ranges are required). The tables may be provided, for example, using same factors for different quality levels, but a different starting quantization value. However, it often is desirable to have a small (or no) jump in quality when an I-frame is transmitted.

At 402, the current quantization quality parameters (which may be, for example, low, normal and/or high qualities) are provided.

At 404, the current parameters are mapped to parameters in the I-frame quantization table, for example, using a translation table. In an exemplary embodiment of the invention, the table is defined as follows: for most values, the same quantization parameter is used. For low values (high quality) a lower quantization parameter is used, for example, by subtracting 1=from the P frame quantization parameter to obtain an I frame quantization parameter. The demarcation line may be, for example, a quantization value of 4, 5 or 6. IN general, it appears that as the quality is lower, the change in quantization is less noticeable, in many cases, the mapping can be one to one, even for low parameter values.

At 406, an I-frame is generated using the quality parameters from the translation table (for the image as a whole or on a macroblock basis)

It should be noted that in some embodiments of the invention, changes, if any, are only required in encoder 104, not decoder 112. Further, the changes may be software, rather than hardware (e.g., new decoding element) changes.

In an exemplary embodiment of the invention, a frame is sampled 5 times a second. A frame is considered static if it does not change during three samples. A typical “normal” quality is 5-6, a low quality is 10 and an improved quality is 1-2. Of course, in other implementations, other values for what is considered high, normal and low qualify may be used, for example a ratio of about 2 or 3 between the quality factors of the different levels. Other values that ⅗ may be used for considering if a frame is static, for example, if a frame does not change in 1, 2 or 3 seconds it may be considered static. Fast changes, in this context, would be for example changes every sample (e.g., 5 times a second).

It should be noted that the human eye will often better tolerate changes in quality level and/or lower quality in moving or changing parts of the image, as compared to static parts of the image. This may be used to select what quality levels are used. The definition of quality may be any standard definition known in the art. In particular, quality as defined as a result of changing equalization (e.g., RMSE) is useful for many applications.

While the above description has focused on broadcasting of media, it may also be used for other applications, for example, for conferencing, in which a background of the display may be relatively static, while a person's face is dynamic.

Software for an exemplary implementation of a preferred embodiment of the invention is described below in a high level form with reference to tables I, II and III. This software is self explanatory and should be usable with minor and/or obvious modification in a wide range of MPEG encoders.

Table I shows software that decides if a macroblock needs refinement.

TABLE I

if ( mbCmd->byCmd=YI_CMD_LAST) // Macro block was not changed

{

if(

(mbi_ptr->is_refinable) & // Is this macro block refinable

(mbi_ptr->quality != MB_QUALITY_REFINED) & // If it is not already refined
(pMpegEncoder->m_TimeTick> // Current time tick
mbi_ptr->m_TimeTick + // Time tick when macro block was changed last time

pGlobals->ReadWriteVars.RefineQualityMblntervalThreshold) // Time threshold for the
macro block refining
& (pMpegEncoder->iPictType!=I_TYPE) // Current frame not I-frame.

)

{

slice_flag=SLICE_CHANGED; mbi_ptr->mb_ext_type=ExREFlNE;

}

}

Table II shows software that is used for compression when there is no refinement, for example, if this is the first time a block is displayed or if no refinement is required.

TABLE II
int aan_intra_fdct(short *block, // Pointer to block
mt dc_prec, // DC precision
mt mq) // Quantizer scale
{
short *postscale=quant_intra_ptr_tab1e[mq>>2]; // Quantization multipliers
short *postscale_round=quant_intra_ptr_round_table[
mq>>]; // Rounding table
jpeg_fdct_ifast_mmx(block); // DCT on block
intra_scale_quant(block, dc_prec, postscale,postscale_round);
// Quantization of intra block
return 1;
}

Table III shows software that is used for compression when there is refinement.

TABLE III

| | |
|---|---|
| int aan_inter_fdct | // Pointer to block |
| (short *block, | |

int dc_prec,int // DC precision

| | |
|---|---|
| mq_old, | // Quantizer scale of unrefined block |
| int max_coeff_old | // Number of coefficient in coded block |
| int mq_new) | // Quantizer scale of refined block |
| { | |

short Temp block[64];
short *postscale=quant_intra_ptr_table[mq_old<<2];
// Quantization multipliers for intra
(short)

| | |
|---|---|
| *postscale_round=quant_intra_ptr_round_table | // Rounding table for intra |
| [mq_old<<2; | |

short *de_quant_quant_intra_ptr_table[mq_old>>2];
// De-quantization multipliers for intra

| | |
|---|---|
| short *inter_quant_mat=quant_inter_ptr_table | // Quantization multipliers for |
| [mq_new>>2]; | // inter |
| short *inter1_quant_mat=quant_inter1_ | // Quantization multipliers for |
| ptr_table[mq_new>>2]; | // inter |
| jpeg_fdct_ifast_mmx(block); // DCT on block | |

memcpy(Temp_block, block, 64*sizeof(short));// Copy of block after DCT
intra_scale_quant(Temp_block, dc_prec,
postscale, postscale_round);

// Quantization of intra block with “unrefined” parameters

intra_de_quant(Temp_block, dc_prec, de_quant,
max_coeff_old);

// De-quantization of intra block with “unrefined” parameters
// used at certain values of ‘Number of coefficient in coded block’

parameter
inter_quant(block, Temp_block, dc_prec, mq_new,
inter_quant_mat inter1_quant_mat);

// Quantization of inter block with refined parameters

return 1;
}

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. In addition, some embodiments are described as method or as apparatus, the scope of the invention includes apparatus, for example, firmware, hardware and/or software for carrying out the method and/or methods for using the apparatus, as well as computer readable media and/or communication signals on which such software is stored.

It is noted that some of the above described embodiments may describe a best mode contemplated by the inventors and therefore include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of transmitting an image over a compressed video transport, as part of an image stream, comprising:
determining at least one quality for at least a part of an image based on a rate of change of said part; and
transmitting said image part at said quality using said transport.

2. A method according to claim 1, comprising:
generating and transmitting a data block of image enhancement data if said image part did not change in a time period.

3. A method according to claim 2, wherein said generating comprises generating without decoding previously used DCT coefficients.

4. A method according to claim 2, wherein said image part is a static image that does not change in at least 30 frames.

5. A method according to claim 2, wherein said image part is a static image that does not change in at least 300 frames.

6. A method according to claim 2, wherein said image part is a static image that does not change in at least 5 seconds.

7. A method according to claim 2, wherein said image part is a static image that does not change in at least 25 seconds.

8. A method according to claim 2, comprising not transmitting image enhancement data once a target image quality is reached for said image part.

9. A method according to claim 2, comprising repeating said generating and said transmitting a maximum of a predetermined number of times for said image part.

10. A method according to claim 2, wherein said transport comprises an MPEG-type transport.

11. A method according to claim 10, comprising decoding said image using a standard MPEG decoder, to have a temporally progressive quality of said image part.

12. A method according to claim 2, comprising calculating a synchronisation frame for said transport by mapping a representation of said image as transmitted to a representation of said image as it should be in a synchronisation frame.

13. A method according to claim 2, comprising associating with said image part an indication of a suitable target quality for said image part.

14. A method according to claim 2, comprising associating with said image part an indication of a suitable initial quality for said image part.

15. A method according to claim 2, comprising associating with said image part an indication of an expected rate of change of said part.

16. A method according to claim 15, comprising generating said indication by an image generator that generates said image.

17. A method according to claim 15, comprising generating said indication by an image encoder that encodes said image.

18. A method according to claim 15, comprising generating said indication by analysing a past profile of changes of said part.

19. A method of calculating a DCT coefficient change value set for updating image values of a previously transmitted portion of an image without motion estimation, comprising:
comparing DCT coefficients that represent said image with at least an approximation of DCT coefficients that represent the transmitted image, to generate an indication of a difference between said coefficients; and
calculating an update coefficient set from said indication of a difference.

20. A method according to claim 19, wherein comparing comprises subtracting.

21. A method according to claim 19, wherein calculating comprises quantizing said difference.

22. A method according to claim 19, wherein said approximation comprises a composite of previously transmitted DCT coefficients and updates.

23. A method according to claim 19, wherein said approximation comprises an AAN-type approximation, in which at least some of multiplication steps required to calculate DCT coefficients are performed as scaling multiplications.

24. A method according to claim 23, wherein said calculating comprises quantizing as part of said scaling multiplication.

25. A method of calculating a synchronisation frame, comprising:
providing a DCT coefficient set that represents a currently displayed image;
mapping said coefficients to a set of quantized coefficients that use a synchronisation frame type quantization.

26. A method according to claim 25, wherein mapping comprises mapping using a table.

27. A method of setting an initial quality of an image part of a compressed video stream, comprising:
selectively determining for at least a part of an image an expected change rate;
compressing said image part at a compression quality different than that of other parts of said stream responsive to said expected change rate.

28. A method according to claim 27, wherein said compression comprises quantizing a set of transform coefficients.

29. A method according to claim 27, wherein said compression comprises compressing responsive to an indication of a desired quality of said image part.

30. A method according to claim 28, wherein said determining comprises determining based on a provided indication.

31. A method according to claim 28, wherein said determining comprises determining based on an analysis of historical changes in said part.

32. A method according to claim 28, wherein said image part is static.

33. A method according to claim 28, wherein said image part is fast varying and is assigned a lower quality than average.

34. A method according to claim 28, wherein said image part is semi-static and is a higher quality than average.

35. A method of transmitting an image over a compressed video transport, as part of an image stream, comprising:
transmitting an image using said transport;
determining that an image part of said image did not change in a time period; and
generating and transmitting a data block of image enhancement data responsive to said determination.

36. A method of calculating a coefficient change value set for updating image values of a previously transmitted portion of an image without motion estimation, which image is transmitted using a transform-type compression system that quantizes a linearly transformed image, comprising:
comparing transform coefficients that represent said image with at least an approximation of transform coefficients that represent the transmitted image, to generate an indication of a difference between said coefficients; and
calculating an update coefficient set from said indication of a difference.
